(19) United States
(12) Patent Application Publication
(10) Pub. No.: US 2021/0324560 A1
(43) Pub. Date: Oct. 21, 2021

(54) INTELLIGENT WASHING MACHINE AND CONTROL METHOD OF THE SAME

(71) Applicant: LG ELECTRONICS INC., Seoul (KR)

(72) Inventor: Yunsik PARK, Seoul (KR)

(73) Assignee: LG ELECTRONICS INC., Seoul (KR)

(21) Appl. No.: 16/495,378

(22) PCT Filed: Jul. 19, 2019
(86) PCT No.: PCT/KR2019/008927

§ 371 Date: Sep. 18, 2019

(51) Int. Cl. D06F 33/36; D06F 34/18; D06F 34/32; D06F 34/30

(52) U.S. Cl. CPC D06F 33/36; D06F 34/18; D06F 2103/46; D06F 34/30; D06F 34/32

(57) ABSTRACT

Disclosed herein is an intelligent washing machine includes: an inner tub in which laundry is accommodated; a driving unit tumbling the laundry by transferring a rotational force to the inner tub; and a controller extracting a control signal for each load related to the tumbling operation of the laundry when activation of an automatic course is detected, recognizing characteristics of the laundry by applying the control signal for each load to a predetermined base learning model, and automatically selecting a washing course that best matches the characteristics of the laundry. The washing machine may be associated with an artificial intelligence (AI) module, an unmanned aerial vehicle (UAV) (or drone), a robot, an augmented reality (AR) device, a virtual reality (VR) device, and a device related to a 5G service.

### TECHNICAL FIELD

The present invention relates to an intelligent washing machine and a control method thereof.

### BACKGROUND ART

In general, a washing machine refers to various apparatuses for treating laundry by applying a physical and/or chemical action to the laundry such as clothing, bedding, and the like. The washing machine includes an outer tub and an inner tub receiving laundry and rotatably installed in the outer tub. A general washing machine operation include washing, rinsing, and spin-drying processes, which starts from selecting a washing course.

The washing course may be set in plurality according to types of laundry or special functions, and control factors necessary for washing, rinsing, and spin-drying processes may be different for each washing course.

The washing course may be selected by a user. The user may select a desired washing course by operating a course selecting part provided in the washing machine. Meanwhile, the washing course may be automatically selected. In this case, a controller built in the washing machine automatically sets the most frequently used washing course by analyzing a usage pattern of the user. That is, the controller sets the washing course only with reference to user history information, rather than setting the washing course on the basis of laundry. Therefore, the method of automatically setting a course of a related art is difficult to match a washing course optimized for laundry.

### DISCLOSURE

### Technical Problem

An embodiment of the present invention aims to solve the above-mentioned problem.

Furthermore, an embodiment of the present invention is to accurately determine a kind of laundry in an automatic washing course process and to select a washing course optimized for corresponding laundry.

### Technical Solution

Furthermore, in this specification, an intelligent washing machine includes: an inner tub in which laundry is accommodated; a driving unit tumbling the laundry by transferring a rotational force to the inner tub; and a controller extracting a control signal for each load related to the tumbling operation of the laundry when activation of an automatic course is detected, recognizing characteristics of the laundry by applying the control signal for each load to a predetermined base learning model, and automatically selecting a washing course that best matches (or most suitable for) the characteristics of the laundry.

The controller may correct the washing course according to a correction command for correcting the washing course regarding the automatically selected washing course, if the correction command is input from the user.

The controller may update the base learning model on the basis of the corrected washing course.

The controller may extract, as the control signal for each load, a motor current pattern or a motor voltage pattern of the driving unit for transmitting a rotational force to the inner tub.

The controller may automatically select a washing course that best matches the characteristics of the laundry, and the characteristics of the laundry may include at least one of a quality and a quantity of the laundry.

The automatic course may be activated through a voice command of the user or a button input of the user.

The intelligent washing machine according to an embodiment of the present invention may further include: a display unit visually displaying the automatically selected washing course for user notification.

The intelligent washing machine according to an embodiment of the present invention may further include: a speaker outputting the automatically selected washing course by voice for user notification.

Furthermore, in this specification, a method of controlling an intelligent washing machine includes: tumbling laundry by transmitting a rotational force to an inner tub in which the laundry is accommodated; extracting a control signal for each load related to the tumbling operation of the laundry when activation of an automatic course is detected; recognizing characteristics of the laundry by applying the control signal for each load to a predetermined base learning model; and automatically selecting a washing course that best matches the characteristics of the laundry.

### Advantageous Effects

According to the present invention, when activation of the automatic course is detected, a control signal for each load related to a tumbling operation of laundry is extracted, characteristics of the laundry are recognized by applying the control signal for each load to the predetermined base learning model, and a washing course that best matches the characteristics of the laundry can be automatically selected.

According to the present invention, in a case where a correction command of a washing course is input by the user regarding an automatically selected washing course, the washing course is corrected according to the correcting command and the base learning model is updated on the basis of the corrected washing course.

Through this, in the present invention, a washing course suitable for usability of the washing machine can be automatically selected and a learning model optimized for the usability of the washing machine may be designed through continuous model updating.

Further, according to the present invention, since laundry is detected on the basis of a control signal for each load, rather than by the existing vision, there is no restriction on intensity of illumination, moisture, and a load amount, and thus, it is possible to more accurately determine laundry characteristics.

### DESCRIPTION OF DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIGS. 4 and 5 are views illustrating an intelligent washing machine according to an embodiment of the present invention.

FIG. 6 is a view illustrating a user interface provided in an intelligent washing machine according to an embodiment of the present invention.

FIG. 7 is a control block diagram of an intelligent washing machine according to an embodiment of the present invention.

FIG. 8 is a view illustrating an example of a configuration of the learning controller of FIG. 7.

FIG. 9 is a flowchart illustrating a method of controlling a washing machine according to an embodiment of the present invention.

FIG. 10 is a flowchart illustrating a method of controlling a washing machine according to another embodiment of the present invention.

FIG. 11 is a view illustrating a method of recognizing laundry characteristics according to another embodiment of the present invention.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

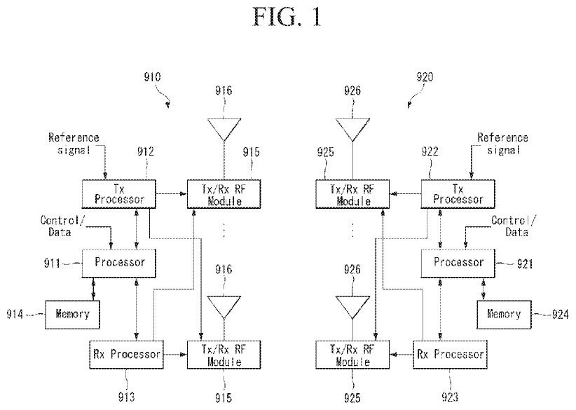

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

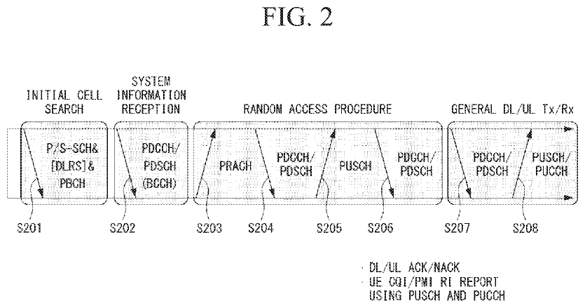

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSB×1, SSB×2, SSB×3, SSB×4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management’ from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

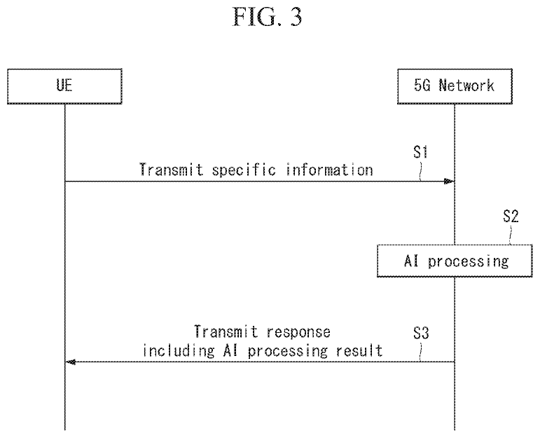

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE(S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

Intelligent Washing Machine

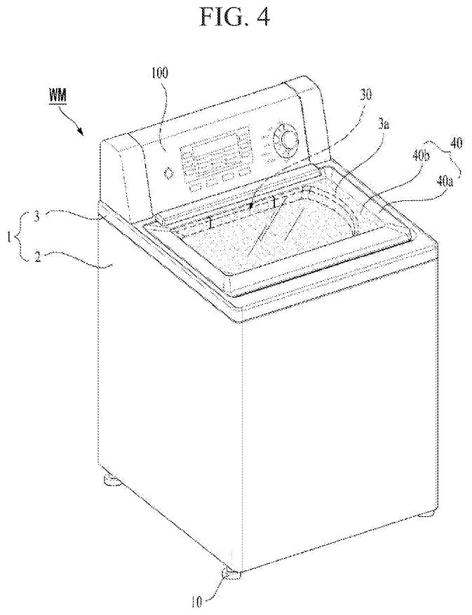

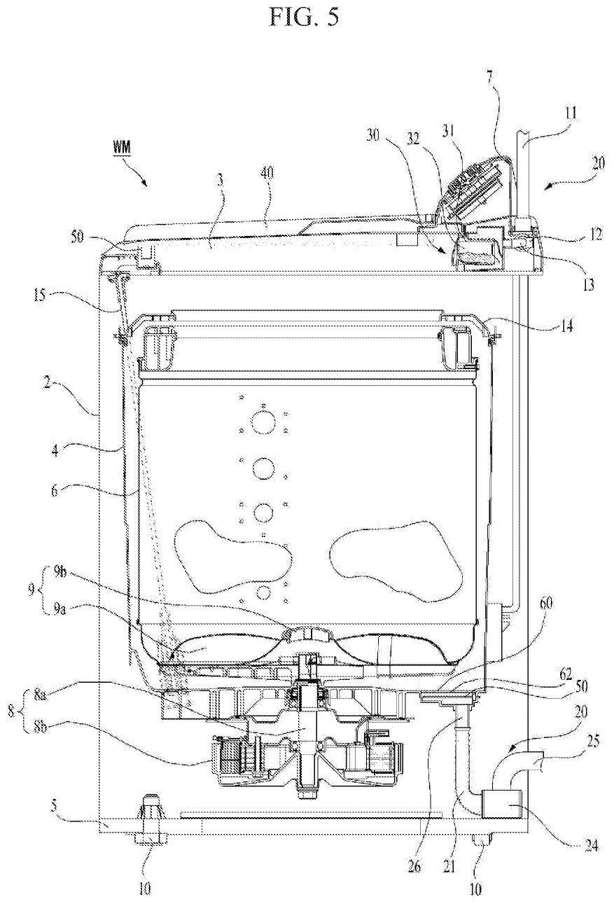

FIGS. 4 and 5 are diagrams illustrating an intelligent washing machine according to an embodiment of the present invention.

Referring to FIGS. 4 and 5, a washing machine WM according to an embodiment of the present invention may be a vertical axis washing machine or a top loading washing machine.

A case 1 may include a side cabinet 2 formed such that upper and lower surfaces thereof are open, a top cover 3 installed to cover the open upper surface of the side cabinet 2, and a base 5 installed on the open lower surface of the cabinet 2.

The cabinet 2 may include an outer tub 4 in which wash water is accommodated, an inner tub 6 disposed on an inner side of the outer tub 4 and accommodating laundry, a driving device 8 including a motor 8b for driving the inner tub 6 and a shaft 8a transferring a driving power from the motor 8 to the inner tub 6 or the like, a water supply unit 30 including a water supply valve 12 to supply water to the inside of the outer tub 4, and a drainage assembly 20 including a drain pump 24 to drain water from the inside of the outer tub 4 after washing or spin-drying is completed.

The water supply unit 30 further includes a detergent box 32 installed on the top cover 3 to temporarily store a detergent. The detergent box 32 may be accommodated in a detergent box housing 31. The detergent box 32 may be detachably attached to the detergent box housing 31 in the form of a drawer.

The water supply unit 30 may include the water supply valve 12 and a water supply hose 13. The water supply valve 12 may be connected to an external hose 11, and wash water may be supplied from an external water source through the external hose 11.

The water supply hose 13 may be connected to the external water source capable of supplying hot water and cold water. That is, a hot water hose and a cold water hose may be provided separately. In this case, the water supply valve 12 may include a hot water supply valve and a cold water supply valve provided separately.

Therefore, when the water supply valve 12 is opened, hot or cold water may be supplied to the detergent box 32 individually or simultaneously. Then, the supplied wash water may be supplied to the inner tub 6 together with the detergent.

The detergent box 32 may be positioned to correspond to the open upper portion of the inner tub 6. Also, the wash water may be supplied to fall toward a bottom surface of the inner tub (6). Therefore, as the wash water is supplied, the laundry accommodated in the inner tub 6 is wetted to some extent by the falling wash water. Here, the wash water containing the detergent will wet the laundry.

A top laundry entry hole 3a is formed on the top cover 3 so that the laundry may be put in or taken out. The top cover 3 includes a door 40 for opening and closing the top laundry entry hole 3a. At least a portion of the door 40 may be formed of glass so that the inside may be visible. That is, the door 40 includes a frame portion 40a and a glass portion 40b inserted into the frame portion 40a.

Further, a control panel 100, i.e., a user interface, for inputting an operation of the washing machine or displaying an operational state of the washing machine may be provided on one side of the top cover 3. The control panel 100 or the user interface may be provided to be distinguished from the cabinet 1 and the door 40 or may be provided as a part thereof.

A user may enter or select object treatment information through the user interface. The user may recognize the currently processed object treatment information through the user interface. Accordingly, the user interface may be an input unit for inputting information and output unit for outputting information.

The outer tub 4 is disposed to be suspended by a plurality of suspensions 15 on an inner upper portion of the cabinet 1. One end of the suspension 15 may be coupled to the inner upper portion of the cabinet 1 and the other end thereof may be coupled to a lower portion of the outer tub 4.

A pulsator 9 for forming a swirl water stream of water accommodated in the outer tub 4 is installed on a bottom surface of the inner tub 6. The pulsator 9 may be integrally formed with the inner tub 6 and rotate together with the inner tub 6 when the motor 8 rotates. In addition, the pulsator 9 may be formed separately from the inner tub 6 and rotate separately when the motor 8 rotates. That is, the pulsator 9 may rotate alone, or the pulsator 9 and the inner tub 6 may rotate simultaneously.

A balancer 12 is installed on the upper side of the inner tub 6 to prevent the inner tub 6 from losing balance due to deviation of the laundry. The balancer 12 may be a liquid balancer filled with a liquid such as brine. An outer tub cover 14 for preventing separation of the laundry and scattering of water is installed on the upper side of the outer tub 4.

Referring to FIG. 2, the drainage assembly 20 includes a first drain hose 21 connected to a drain hole 26 formed on a lower surface of the outer tub 4, a drain pump housing 24 including a drain pump for pumping water, and a second drain hose 25 connected to the drain pump housing 24 to drain water pumped by the drain pump to the outside of the cabinet 2. A drain motor for driving the drain pump is included in the drain pump housing 24. The drainage assembly 20 may be disposed between the outer tub 4 and the base 5. A washing heater 50 for heating wash water and a heater cover 60 covering the upper side of the heater 50 may be installed at a lower portion of the outer tub 4.

The inside of the object accommodating unit is provided with an environment for processing an object, which is different from an external environment. In particular, temperature and humidity differ. In the case of a washing machine, wash water is accommodated in the object accommodating unit. Therefore, it is common that the object is treated with the door 40 closed. To this end, a door sensor 50 for detecting a closed state of the door 40 may be provided, and the door sensor 50 may be provided in the door 1 or the cabinet 1 corresponding to the door. For example, the door sensor 50 may be provided on the top cover 3. When it is detected through the door sensor 50 that the door is closed, the object is treated. Power is applied to operate the door sensor 50.

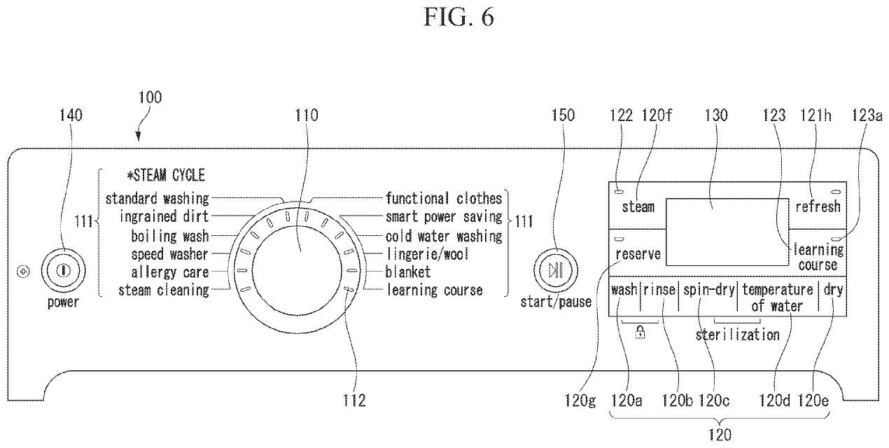

FIG. 6 is a view illustrating a user interface provided in an intelligent washing machine according to an embodiment of the present invention. FIG. 6 illustrates an example of a user interface of a washing machine and illustrates an example of a user interface of a washing machine capable of performing not only a washing function but also a drying function.

In the case of a washing machine, the object treatment information may include course information. The course information refers to an algorithm previously set to sequentially perform a series of processes for laundry treatment, for example, washing, rinsing, and spin-drying. Each course may have different control factors for the corresponding processes.

Accordingly, the course information may be provided in plurality. The course information may be provided in plurality according to a kind of an object or a special function. Each course information includes sub-information. Therefore, the object treatment information may include sub-information as well as course information.

In the case of the washing machine, the sub-information may include at least one of a temperature of wash water, a water level of wash water, an RMP for spin-drying, a washing strength, a washing time, the number of rinsing, and the presence or absence of steam.

A main function of the washing machine is washing. Accordingly, in the case of the washing machine, the course selecting unit 110 or a main function selecting unit for selecting a washing course may be provided and the user selects a course therethrough. For example, the course selecting unit 110 may be provided in the form of a rotary knob. To facilitate course selection of the user, the control panel 100 may have a course display unit 111, and the user may select a desired washing course by operating the course selecting unit 110 to correspond to the course display unit.

FIG. 6 illustrates the course display unit 111 displaying various washing courses around the rotary knob 110. The user may select a corresponding washing course by rotating the rotary knob 110. That is, the user may select course information through the course selecting unit such as the rotary knob 110. A course display unit 112 for displaying the selected washing course may be provided, through which the user may easily recognize the selected washing course. The display unit 112 may be implemented through a flashing LED.

An option selecting unit 120 for selecting an option function added or changed in performing the main function described above. That is, the option selecting unit 120 may be provided to select sub-information for the course information. The option selecting unit 120 may be provided in various ways. FIG. 6 shows an option selecting unit 120 for selecting options related to washing 120a, rinsing 120b, spin-drying 120c, water temperature 120d, drying 120e, steam 120f, reservation 120g, and refreshing 120h. An option selecting unit 120 is shown that may be selected. An option display unit 122 indicating whether such an option is selected may also be provided, and may be similarly implemented through an LED or the like.

The control panel 100 may include a state display unit 130 displaying a state of the washing machine. The state display unit 130 may display a current operational state of the washing machine or a course, option and time information selected by the user.

For example, when the washing machine performs the rinsing step, it may be displayed as “in the rinsing step”. And, if the user waits for a course input, it may be displayed as “Please enter washing course”. In addition, a current time or a time (residual time) remaining until the washing machine completes the operation by performing the washing course may be displayed.

Meanwhile, the control panel 100 may include a power input unit 140 for applying and releasing power of the washing machine and an operation/pause selecting unit 150 for executing or pausing the washing machine. The operation/pause selecting unit may be referred to as a start input unit for convenience.

Accordingly, the user inputs object treatment information through the course selecting unit 110 and/or the option selecting unit 120, and an object is treated according to the input treatment information. This series of processes may be referred to as manual setting mode.

An example of the manual setting mode will be described below.

The user opens the door 40, puts in the object, and closes the door 40. After power is applied through the power input unit 140, a standard washing course may be selected through the course selecting unit 110, and a steam option may be selected through the steam option selecting unit 120f.

RMP for spin-drying is selected to be higher than a predetermined value (value set as default in the standard washing course) through a spin-drying option selecting unit 120c, and 40 degrees Celsius higher than a predetermined value (value set as default in the standard washing course, for example, cold water) may be selected through a water temperature option selecting unit 120d. The input object treatment information may be displayed on the corresponding display units 112 and 122 or the display 130.

When the input of the object treatment information is terminated, the user inputs the start input unit 150, and thereafter, the home appliance automatically treats the object on the basis of the input treatment information and is subsequently terminated.

The present embodiment may provide a washing machine capable of providing an automatic setting mode as well as the manual setting mode described above. That is, the washing machine in which object treatment information is automatically set, without having to input object treatment information, whenever the user wants to treat the object, may be provided. In particular, the present embodiment may provide a washing machine that evolves, while performing learning. In addition, the present embodiment may provide the washing machine allowing the user to recognize whether the learning is performed and the washing machine evolves, thus increasing user's satisfaction.

In the present embodiment, the washing machine may set the washing course by learning characteristics of laundry through a control signal for each load and course input information of the user. That is, even if the user does not manually input the course information, the washing machine may set the course information by reflecting a learning result.

While the user uses the washing machine through the manual setting mode, the washing machine may continuously perform learning. That is, the learning process may be performed through control signal information for each load and treatment information obtained through the user interface. Details of the learning process will be described later.

The course set by reflecting the result of the learning process may be called a learning course. The mode in which the treatment information is set using the learning course may be referred to as a learning setting mode. Unlike the manual setting mode described above, the learning setting mode may refer to automatically setting treatment information even if the user does not manually input the treatment information. For example, when the user selects the learning course selecting unit 123, the learning setting mode may be used as a default.

An example of the learning setting mode is as follows.

The user opens the door 40, puts in an object, and closes the door 40. After power is applied through the power input unit 140, the learning course selecting unit 123 may be input. When the learning course selecting unit 123 is input, current washing course information is set through a current learning process result and a currently obtained control signal for each load. That is, the washing course information may be set without inputting the treatment information by the user. At this time, it is preferable that the user recognizes that the set washing course information is treatment information reflecting learning.

To this end, preferably, a process of outputting a learning result is displayed for about one to two seconds for user recognition. For example, the display through the display 130, the plurality of LEDs are variably lit, in a state where a plurality of LEDs are variably turned on, only an LED corresponding to the set treatment information may be turned on. In addition, voice through the speaker may be guided.

The user may approve the set treatment information through the start input unit 150. Also, the user may approve the set treatment information by inputting a voice through a microphone. When the approval step is completed, a washing process for laundry may be performed on the basis of the set washing course information.

Meanwhile, the user may directly enter new washing course information without approval in the approval step. In this case, forced learning may be performed through the currently obtained control signal information for each load and newly input washing course information. That is, injection learning or forced learning may be performed by the user. The results of such injection learning or forced learning may be prioritized over learning results of other processes. That is, the learning result through the forced learning may be given priority over the learning result through the manual setting mode. By reflecting priority of the learning result in the washing machine, the user may recognize that the washing machine evolves by learning.

If the learning setting mode is performed immediately after the learning course selecting unit 123 is input, the learning course selecting unit 123 may be selected as a default. That is, the learning course selection may be continuously maintained unless the user inputs the learning course selecting unit 123 again. Even if the power is turned off after the laundry treatment using the learning course is finished, the learning course selecting unit 123 may be selected as a default when power is subsequently applied.

The learning course selecting unit 123 may be provided separately from the course input unit 110 or may be provided as a portion of the course input unit 110. Even in the latter case, selecting and reflecting the learning course are the same as described above.

The reason for providing the learning course selecting unit 123 in either case may be to allow the user selectively use the manual setting mode and the learning setting mode. If the automatic setting mode is preferred to the manual setting mode from initial use of the washing machine, the learning course selecting unit 123 may be omitted. That is, if a sufficient amount of learning results is provided or there are learning results corresponding to the currently obtained control signal for each load, the learning setting mode may be performed. Conversely, if a sufficient amount of learning results are not provided or there are no learning results corresponding to the currently obtained control signal for each load, the forced learning described above may be performed.

In the case of forced learning, the user must manually input the treatment information. In this case, however, the user may recognize through the user interface that the washing machine learns and evolves to perform the learning setting mode. Therefore, preferably, the user interface includes a microphone and/or a speaker.

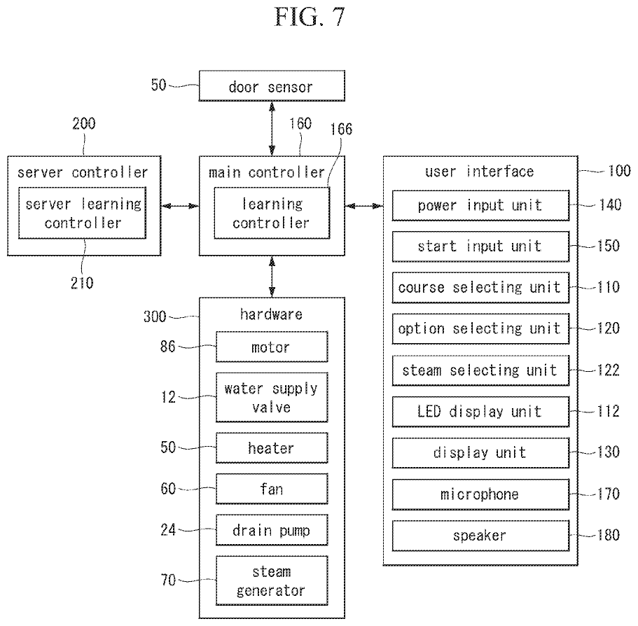

FIG. 7 is a control block diagram of an intelligent washing machine according to an embodiment of the present invention.

Referring to FIG. 7, the washing machine may include a main controller or a main processor 160 controlling sequential processes of laundry treatment. The main controller 160 controls driving of the hardware 300 to perform set treatment information. The hardware 300 may be variously provided for each washing machine. The washing machine may include a motor 86 for driving the inner tub 6 as an object accommodating portion and a drum, a water supply valve 12, a heater 50, a drain pump 24. If a heater for generating steam is provided separately from the heater 50, the hardware 300 may include a steam generator 70. A separate heater or fan 60 for drying may also be included in the hardware.

A learning controller or learning processor 166 for performing learning and outputting a learning result may be provided. The learning processor 166 may be provided separately from the main processor or installed in the main processor. In the learning processor 166, a learning algorithm or learning logic, which will be described later, may be programmed

A control signal for each load for the operation of the motor 86 and treatment information input through the user interface 100 may be transferred to the main controller 160. The image information and treatment information transferred to the main controller 160 may be transferred to the learning controller 166. Of course, at least one of the image information and the treatment information may be directly transferred to the learning controller 166. The learning process may be performed by the learning processor 166 and may use the image information as an input factor and treatment information as output information.

Meanwhile, recently, many smart washing machines which communicate with a server have been provided. That is, the washing machine includes a communication module (not shown) to communicate with the server. Accordingly, the learning processor 166 may be omitted in the washing machine, and a server learning controller or the processor 210 may be provided in the server controller 200 instead. That is, the washing machine may transfer an input factor of a learning process to the server, and the server may perform learning and transfer a learning result to the washing machine. In this case, since the washing machine does not require a separate learning processor, a product cost may be reduced.

Meanwhile, if the user wants a washing machine of his or her own or a washing machine specialized for himself or herself, preferably, the washing machine has a separate learning processor 166.

The washing machine includes a user interface 100. Input and output of treatment information may be performed through the user interface 100. An example of specific components of the user interface has been described above with reference to FIG. 6.

Various input units or selecting units 140, 150, 110, 120, and 122 in the user interface 100 may be provided to allow the user to physically select or input the input units or the selecting units. The input units or selecting units may be provided in any form of a button or a touch panel input through a physical contact or pressing. Such an input or selecting unit may be provided through a touch menu in a touch display.

However, a power input unit may be provided in the form of a physical button separately from the other input units for the reasons of user experience or a reduction of standby power. In other words, the power input unit may be provided in the form of a power application switch. The start input unit 150 facing the power input unit 140 may also be provided in the form of a physical button.

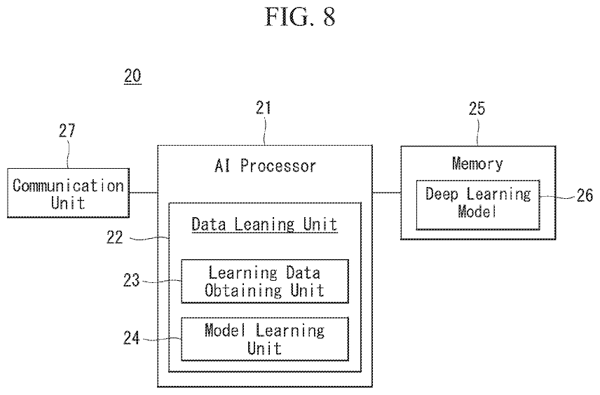

FIG. 8 is a view illustrating an example of a configuration of the learning controller 166 of FIG. 7.

Referring to FIG. 8, the learning controller 166 may include an electronic device including an AI module capable of performing artificial intelligence (AI) processing or a server including an AI module. In addition, the learning controller 166 may be included as a component of at least a portion of the washing machine WM described above and may be provided to perform at least a portion of the AI processing. AI processing may include all operations related to the learning controller 166.

The learning controller 166 may be a client device that directly uses an AI processing result or may be a device in a cloud environment that provides the AI processing result to another device. The learning controller 166, as a computing device capable of learning a neural network, may be implemented as various electronic devices such as a server, a desktop PC, a notebook PC, a tablet PC, and the like.

The learning controller 166 may include an AI processor 410, a memory 420, and/or a communication unit 430.

The AI processor 410 may learn a neural network using a program stored in the memory 420. In particular, the AI processor 410 may learn a neural network for recognizing laundry. Here, the neural network for recognizing the laundry may be designed to simulate a human brain structure in a computer and include a plurality of network nodes having weights which simulate neurons of the human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 420 can store various programs and data for the operation of the Learning controller 166. The memory 420 may be a nonvolatile memory, a volatile memory, a flash-memory, a hard disk drive (HDD), a solid state drive (SDD), or the like. The memory 420 is accessed by the AI processor 410 and reading-out/recording/correcting/deleting/updating, etc. of data by the AI processor 410 can be performed. Further, the memory 420 can store a neural network model (e.g., a deep learning model 425) generated through a learning algorithm for data classification/recognition according to an embodiment of the present invention.

Meanwhile, the AI processor 410 may include a data learning unit 412 that learns a neural network for data classification/recognition. The data learning unit 412 can learn references about what learning data are used and how to classify and recognize data using the learning data in order to determine data classification/recognition. The data learning unit 412 can learn a deep learning model by acquiring learning data to be used for learning and by applying the acquired learning data to the deep learning model.

The data learning unit 412 may be manufactured in the type of at least one hardware chip and mounted on the Learning controller 166. For example, the data learning unit 412 may be manufactured in a hardware chip type only for artificial intelligence, and may be manufactured as a part of a general purpose processor (CPU) or a graphics processing unit (GPU) and mounted on the Learning controller 166. Further, the data learning unit 412 may be implemented as a software module. When the data leaning unit 412 is implemented as a software module (or a program module including instructions), the software module may be stored in non-transitory computer readable media that can be read through a computer. In this case, at least one software module may be provided by an OS (operating system) or may be provided by an application.

The data learning unit 412 may include a learning data acquiring unit 414 and a model learning unit 416.

The learning data acquiring unit 414 can acquire learning data required for a neural network model for classifying and recognizing data. For example, the learning data acquiring unit 414 can acquire, as learning data, vehicle data and/or sample data to be input to a neural network model.

The model learning unit 416 can perform learning such that a neural network model has a determination reference about how to classify predetermined data, using the acquired learning data. In this case, the model learning unit 416 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 416 can train a neural network model through reinforcement learning using feedback about whether the result of situation determination according to learning is correct. Further, the model learning unit 416 can train a neural network model using a learning algorithm including error back-propagation or gradient decent.

When a neural network model is learned, the model learning unit 416 can store the learned neural network model in the memory. The model learning unit 416 may store the learned neural network model in the memory of a server connected with the Learning controller 166 through a wire or wireless network.

The data learning unit 412 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 416 can use learning data acquired for learning for image recognition.

Further, the learning data selector can select data for learning from the learning data acquired by the learning data acquiring unit 414 or the learning data preprocessed by the preprocessor. The selected learning data can be provided to the model learning unit 416. For example, the learning data selector can select only data for objects included in a specific area as learning data by detecting the specific area in an image acquired through a camera of a vehicle.

Further, the data learning unit 412 may further include a model estimator (not shown) to improve the analysis result of a neural network model.

The model estimator inputs estimation data to a neural network model, and when an analysis result output from the estimation data does not satisfy a predetermined reference, it can make the model learning unit 416 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 430 can transmit the AI processing result by the AI processor 410 to an external electronic device.

Here, the external electronic device may be defined as an autonomous vehicle. Further, the Learning controller 166 may be defined as another vehicle or a 5G network that communicates with the autonomous vehicle. Meanwhile, the Learning controller 166 may be implemented by being functionally embedded in an autonomous module included in a vehicle. Further, the 5G network may include a server or a module that performs control related to autonomous driving.

Meanwhile, the learning controller 166 shown in FIG. 8 was functionally separately described into the AI processor 410, the memory 420, the communication unit 430, etc., but it should be noted that the aforementioned components may be integrated in one module and referred to as an AI module.

Method of Controlling Intelligent Washing Machine

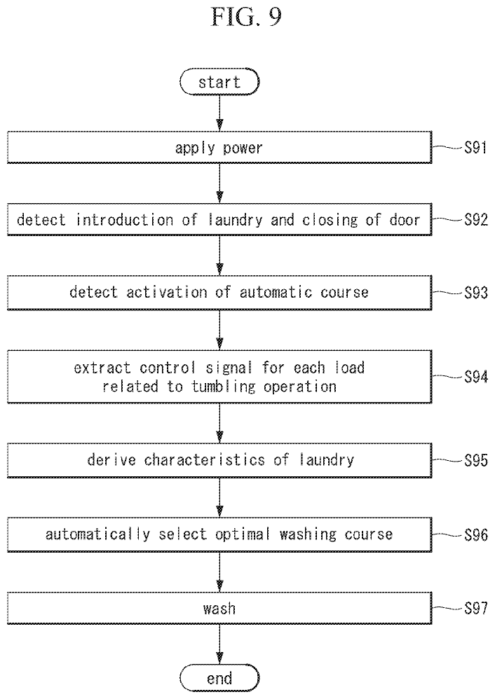

FIG. 9 is a flowchart illustrating a method of controlling a washing machine according to an embodiment of the present invention.

Referring to FIG. 9, the control method of the washing machine according to an embodiment of the present invention includes steps S91 to S97 which are sequentially performed.

In step S91, power is supplied.

In step S92, introduction of laundry and closing of a door are detected.

In step S93, it is detected whether an automatic course is activated. The automatic course may be activated by a voice command of the user or a button input of the user.

In step S94, a control signal for each load related to a tumbling operation of the laundry is extracted on the assumption that activation of the automatic course is detected. The control signal for each load may include a motor current pattern or a motor voltage pattern required for tumbling the laundry.

In step S95, characteristics of the laundry is recognized by applying the control signal for each load to a predetermined base learning model. The characteristics of the laundry includes at least one of a quality and a quantity of the laundry. The method of using a control signal for each load has several advantages as compared with a method of using a load image. The method of using a load image as a result of sensing by a camera (vision sensor) is difficult to accurately recognize characteristics of laundry if the laundry is aggregated and image accuracy changes sensitively depending on intensity of illumination, humidity, and a load amount. In contrast, since the present invention detects laundry on the basis of the control signal for each load, there is no restriction in intensity of illumination, humidity, and a load amount, and thus the characteristics of the laundry may be more accurately recognized.

In step S96, a washing course that best matches the characteristics of the laundry is automatically selected. In this case, the automatically selected laundry course may be notified to the user via visual/acoustic means.

In step S97, a washing process is performed.

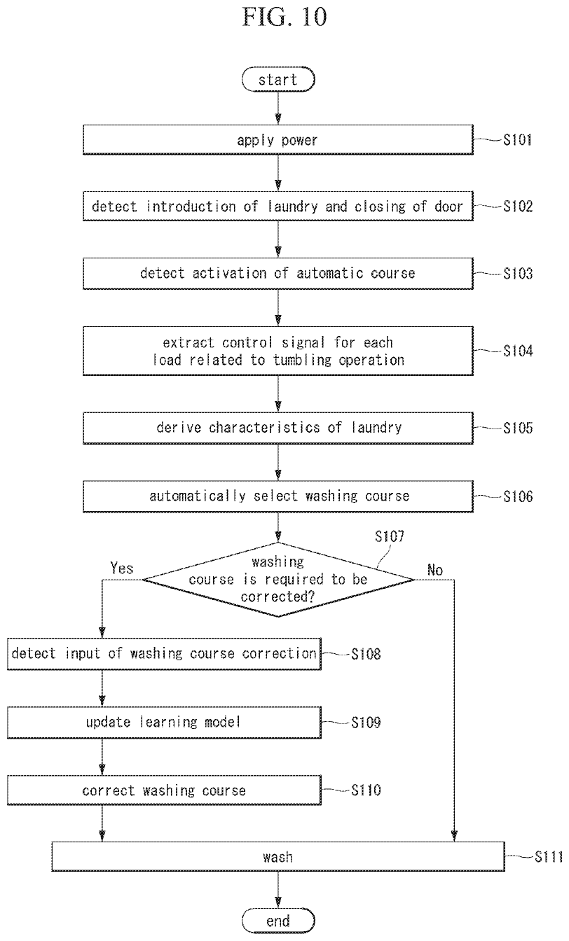

FIG. 10 is a flowchart illustrating a method of controlling a washing machine according to another embodiment of the present invention.

Referring to FIG. 10, a method of controlling a washing machine according to another embodiment of the present invention includes S101 to S111 which are sequentially performed.

In step S101, power is applied.

In step S102, introduction of laundry and closing of the door are detected.

In step S103, it is detected whether an automatic course is activated. The automatic course may be activated by a voice command of the user or a button input of the user.

In step S104, a control signal for each load related to a tumbling operation of the laundry is extracted on the assumption that activation of the automatic course is detected. The control signal for each load may include a motor current pattern or a motor voltage pattern required for tumbling the laundry.

In step S105, characteristics of the laundry is recognized by applying the control signal for each load to a predetermined base learning model. The characteristics of the laundry includes at least one of a quality and a quantity of the laundry. The method of using a control signal for each load has several advantages as compared with a method of using a load image. The method of using a load image as a result of sensing by a camera (vision sensor) is difficult to accurately recognize characteristics of laundry if the laundry is aggregated and image accuracy changes sensitively depending on intensity of illumination, humidity, and a load amount. In contrast, since the present invention detects laundry on the basis of the control signal for each load, there is no restriction in intensity of illumination, humidity, and a load amount, and thus the characteristics of the laundry may be more accurately recognized.

In steps S106 and S107, a washing course that matches the characteristics of the laundry is automatically selected. In this case, the automatically selected laundry course may be notified to the user via visual/acoustic means. The user may automatically determine whether a correction is required for the automatically selected washing course, and directly perform correction. Correction by the user may include correcting the washing course itself and correcting various sub-information as well. The sub-information may include spin-drying RPM information or the like, but is not limited thereto.

In steps S108 and S109, when a washing course correction instruction is input by the user, sub-correction information together with course correction information may be used for learning. That is, the user correction information may be updated and reflected in the learning model. Through this updating, the user correction information takes precedence over the automatic selection information before correction.

In steps S110 and S111, a washing process is performed after the washing course is corrected according to the correction instruction.

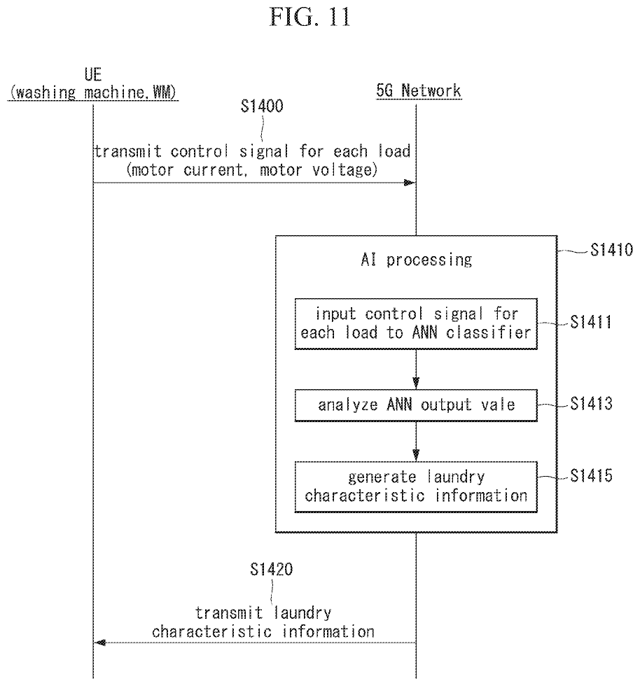

FIG. 11 is a view illustrating a method of recognizing laundry characteristics according to another embodiment of the present invention.

The controller 160 may control the communication unit to transmit state information of the washing machine WM, that is, a control signal for each load according to laundry, to the AI processor included in the 5G network. Further, the controller 160 may control the communication unit to receive AI-processed information, that is, laundry characteristic information, from the AI processor.

The controller 160 may transmit the control signal for each load and user correction information to the network on the basis of a DCI (S1400). The control signal for each load and the user correction information may be transmitted to the network through a physical uplink shared channel (PUSCH), and a synchronization signal block (SSB) and a demodulation reference signal (DM-RS) of the PUSCH may be quasi-co-located, QCL, for a QCL type D. Here, the 5G network may include an AI processor or an AI system, and the AI system of the 5G network may perform AI processing on the basis of the received control signal information for each load and the user correction information.

The AI system may input image information or feature values received from the controller 160 to the ANN classifier (S1411). The AI system analyzes an ANN output value (S1413), and recognizes laundry characteristics (laundry quality and/or quantity) from the ANN output value (S1415).

The 5G network may transmit the laundry characteristic information generated by the AI system to the washing machine WM through the wireless communication unit (S1420).

The components described herein are to be considered as illustrative and not restrictive in all aspects. The scope of the present invention should be determined by reasonable interpretation of the appended claims, and all changes within the equivalent range of the present invention are included in the scope of the present invention.

What is claimed is:

1. An intelligent washing machine comprising:
an inner tub in which laundry is accommodated;
a driving unit tumbling the laundry by transferring a rotational force to the inner tub; and
a controller extracting a control signal for each load related to the tumbling operation of the laundry when activation of an automatic course is detected, recognizing characteristics of the laundry by applying the control signal for each load to a predetermined base learning model, and automatically selecting a washing course that best matches the characteristics of the laundry.

2. The intelligent washing machine of claim 1, wherein
the controller corrects the washing course according to a correction command for correcting the washing course regarding the automatically selected washing course, if the correction command is input from the user.

3. The intelligent washing machine of claim 2, wherein
the controller updates the base learning model on the basis of the corrected washing course.

4. The intelligent washing machine of claim 1, wherein
the controller extracts, as the control signal for each load, a motor current pattern or a motor voltage pattern of the driving unit for transmitting a rotational force to the inner tub.

5. The intelligent washing machine of claim 4, wherein
the controller automatically selects a washing course that best matches the characteristics of the laundry, and the characteristics of the laundry includes at least one of a quality and a quantity of the laundry.

6. The intelligent washing machine of claim 1, wherein
the automatic course is activated through a voice command of the user or a button input of the user.

7. The intelligent washing machine of claim 1, further comprising:
a display unit visually displaying the automatically selected washing course for user notification.

8. The intelligent washing machine of claim 7, further comprising:
a speaker outputting the automatically selected washing course by voice for user notification.

9. A method of controlling an intelligent washing machine, the method comprising:
tumbling laundry by transmitting a rotational force to an inner tub in which the laundry is accommodated;
extracting a control signal for each load related to the tumbling operation of the laundry when activation of an automatic course is detected;
recognizing characteristics of the laundry by applying the control signal for each load to a predetermined base learning model; and
automatically selecting a washing course that best matches the characteristics of the laundry.

10. The method of claim 9, further comprising:
correcting the washing course according to a correction command for correcting the washing course regarding the automatically selected washing course, if the correction command is input from a user.

11. The method of claim 10, wherein
updating the base learning model on the basis of the corrected washing course.

12. The method of claim 9, wherein
the control signal for each load comprises a motor current pattern or a motor voltage pattern necessary for tumbling the laundry.

13. The method of claim 12, wherein
the controller automatically selects a washing course that best matches the characteristics of the laundry, and the characteristics of the laundry includes at least one of a quality and a quantity of the laundry.

14. The method of claim 9, wherein
the automatic course is activated through a voice command of the user or a button input of the user.

15. The method of claim 9, further comprising:
visually displaying the automatically selected washing course for user notification.

16. The method of claim 15, further comprising:
outputting the automatically selected washing course by voice for user notification.
